(19) United States
(12) Patent Application Publication
(10) Pub. No.: US 2020/0332759 A1
(43) Pub. Date: Oct. 22, 2020

(54) Internal-Combustion-Engine Control Unit and Internal-Combustion-Engine Control Method

(71) Applicant: Hitachi Automotive Systems, Ltd., Hitachinaka-shi, Ibaraki (JP)

(72) Inventors: Kazuhiro ORYOJI, Tokyo (JP); Yoshihiko AKAGI, Hitachinaka-shi (JP)

(21) Appl. No.: 16/959,888

(22) PCT Filed: Jan. 31, 2019
(86) PCT No.: PCT/JP2019/003285

§ 371 Date: Jul. 2, 2020

(30) Foreign Application Priority Data
Feb. 26, 2018 (JP) 2018-032047

(51) Int. Cl. F02P 5/152; G01L 23/22

(52) U.S. Cl. CPC F02P 5/152; G01L 23/221

(57) ABSTRACT

An internal-combustion-engine control unit and control method are provided that can prevent an excessive ignition-timing retard while occurrences of knocking are suppressed. An internal-combustion-engine control unit that controls an internal-combustion engine, the internal-combustion-engine control unit including: a knock-occurrence-frequency sensing section that senses a knock occurrence-frequency of a cylinder; and a cylinder-wall-temperature computing section that computes a wall temperature of the cylinder on a basis of the knock occurrence-frequency sensed at the knock-occurrence-frequency sensing section.

### TECHNICAL FIELD

The present invention relates to an internal-combustion-engine control unit and control method, and in particular relates to a technology which is effective in making an internal-combustion engine highly efficient.

### BACKGROUND ART

In recent years, vehicles such as automobiles are a target of stricter fuel-efficiency-related, and exhaust-related restrictions, and such restrictions are thought to be still stricter hereafter. In particular, fuel-efficiency-related restrictions are a matter of much interest because of problems such as the steep rise of fuel prices, influences on global warming or depletion of energy resources that are observed in recent years.

In such a situation, in the automobile industry for example, various technological developments are under way for the purpose of enhancing fuel-efficiency performance and exhaust performance of vehicles. One of such technologies that are being developed technology for the purpose of enhancing fuel-efficiency performance is the high compression ratio technology by which the compression ratio of an internal-combustion engine is increased, for example. In addition, one of such technologies that are being developed for the purpose of enhancing exhaust performance is the multi-stage injection technology by which a fuel is injected multiple times separately during an intake stroke, and the fuel-injection amount per instance of injection is reduced to reduce the PN (Particulate Number), for example.

Meanwhile, it is known that, in the high compression ratio technology described above, if the compression ratio of an internal-combustion engine is increased, the thermal efficiency is enhanced and the fuel efficiency improves, but the temperature in combustion chambers rises and knocking occurs more easily.

Accordingly, in conventional internal-combustion engines, by making use of the fact that the signal levels of particular frequencies in vibrations of the engine block and a cylinder inner pressure rise at the time of an occurrence of knocking, a vibration-type knock sensor is attached to the cylinder block. With the knock sensor, signals of a predetermined period (knock window) output from the knock sensor are subjected to FFT (fast Fourier transform) analysis to sense an occurrence of knocking, and the ignition timing is retarded after the occurrence of knocking on the basis of the sensing information, to thereby avoid subsequent occurrences of knocking.

Methods of controlling the ignition timing in order to avoid occurrences of knocking include the prior art represented by technologies like the ones mentioned below, for example.

### PRIOR ART DOCUMENT

### Patent Documents

Patent Document 1: JP-2014-25449-A

Patent Document 2: JP-2004-44543-A

### SUMMARY OF THE INVENTION

### Problems to be Solved by the Invention

Patent Document 1 described above discloses that an ignition retard amount is set in accordance with the sampling value (frequency) of vibration signals as the degree of a sensed knock. Furthermore, Patent Document 1 discloses that as the sampling value of vibration signals increases, a slower advance rate after an ignition retard is set.

In addition, in consideration of a response of the wall-surface temperature that responds later than the temperature of an engine coolant does, Patent Document 2 described above discloses means for computing a parameter that is correlated with a wall-surface temperature in a transient period and correcting the ignition timing.

In the technology of Patent Document 1, it is possible to set an ignition retard amount and an advance rate after an ignition retard according to the degree of a knock, but the influence of the wall temperature which is one of control factors of knocks is not taken into consideration, and there is a possibility that an excessive ignition retard period is generated.

In addition, the technology in Patent Document 2 is effective as an ignition-timing control technique under conditions where differences arise between changes in the engine coolant temperature and changes in the wall-surface temperature. However, it is difficult to apply the technology under conditions where, although the wall temperature changes as a result of high-load running for a short time, temperature changes of the engine coolant remain small.

In view of this, an object of the present invention is to provide an internal-combustion-engine control unit and control method that can prevent an excessive ignition-timing retard while occurrences of knocking are suppressed, by estimating the state of the temperature of the wall of a cylinder on the basis of a knock index correlated with the wall temperature and controlling the ignition timing on the basis of the estimated wall temperature.

### Means for Solving the Problems

In order to solve the problems described above, the present invention provides an internal-combustion-engine control unit that controls an internal-combustion engine, the internal-combustion-engine control unit including: a knock-occurrence-frequency sensing section that senses a knock occurrence-frequency of a cylinder; and a cylinder-wall-temperature computing section that computes a wall temperature of the cylinder on a basis of the knock occurrence-frequency sensed at the knock-occurrence-frequency sensing section.

In addition, the present invention provides an internal-combustion-engine control method of controlling an internal-combustion engine, the internal-combustion-engine control method including: a step (a) of sensing a knock occurrence-frequency of a cylinder; and a step (b) of computing a wall temperature of the cylinder on a basis of the knock occurrence-frequency sensed at the step (a). In the internal-combustion-engine control method, an ignition timing of the internal-combustion engine is controlled on a basis of the wall temperature of the cylinder computed at the step (b).

### Advantages of the Invention

According to the present invention, it is possible to prevent an excessive ignition-timing retard in an internal-combustion engine while occurrences of knocking are suppressed, and it is possible to attempt to enhance fuel efficiency.

Problems, configurations and effects other than those described above are made clear by the following explanations of embodiments.

### BRIEF DESCRIPTION OF THE DRAWINGS

FIG. 1 is an overall-configuration diagram of an internal-combustion engine according to one embodiment of the present invention.

FIG. 2 is a block diagram illustrating the internal configuration of a control unit (ECU) in FIG. 1.

FIG. 3 is a system configuration diagram of the control unit (ECU) in FIG. 2.

FIG. 4 is a figure illustrating an example of an ignition-timing control value.

FIG. 5 is a flowchart illustrating a process of a knock-occurrence-frequency sensing section in FIG. 3.

FIG. 6 is a figure illustrating the relationship between the vibration intensity and the frequency of an engine block at the time of a knock occurrence.

FIG. 7 is a figure illustrating an example of a knock occurrence-frequency (knock-occurrence interval).

FIG. 8 is a flowchart illustrating a process of a cylinder-wall-temperature computing section in FIG. 3.

FIG. 9 is a figure illustrating the relationship between a knock occurrence-frequency and a wall temperature.

FIG. 10 is a figure illustrating the relationship between a knock occurrence-frequency and a wall-temperature relative value (the difference from a temperature compliance value).

FIG. 11 is a system configuration diagram of an ignition-timing control section in FIG. 3.

FIG. 12 is a flowchart illustrating a process of an ignition-retard-amount control section in FIG. 11.

FIG. 13 is a flowchart illustrating a process of an ignition-retard-period control section in FIG. 11.

FIG. 14 is a flowchart illustrating a process of an ignition-advance control section in FIG. 11.

FIG. 15 is a figure illustrating the relationship between an ignition timing and a torque.

FIG. 16 is a figure illustrating the relationship between a wall (wall-surface) temperature and an ignition-advance-rate correction amount.

FIG. 17 is a figure illustrating an operation example of one embodiment of the present invention in a low wall-temperature condition.

FIG. 18 is a figure illustrating an operation example of one embodiment of the present invention in a high wall-temperature condition.

### MODES FOR CARRYING OUT THE INVENTION

Hereinafter, embodiments of the present invention are explained by using the drawings. Note that identical configurations are given the same reference characters throughout the drawings, and detailed explanations of overlapping portions are omitted.

### First Embodiment

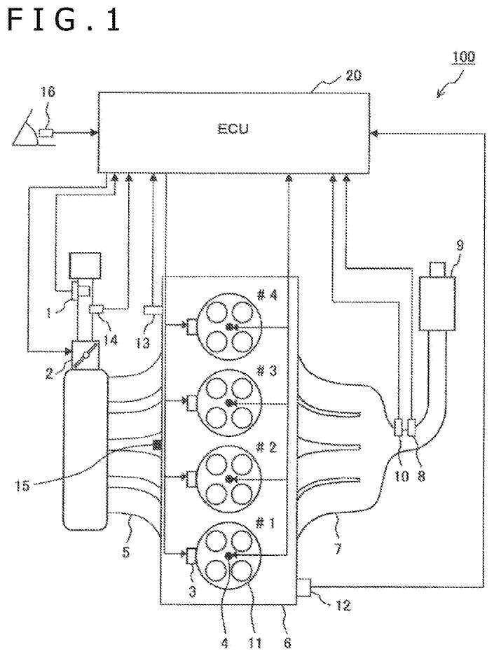

First, an internal-combustion engine in the present embodiment is explained with reference to FIG. 1. FIG. 1 illustrates the overall configuration of the internal-combustion engine to which an embodiment of an internal-combustion-engine control unit according to the present invention is applied, and illustrates a four-cylinder gasoline engine for automobiles that performs spark ignition combustion, for example.

An illustrated engine (internal-combustion engine) 100 includes, at appropriate positions of intake pipes 5, an air flow sensor 1 that measures an intake-air volume, an electronic control throttle 2 that adjusts the volume of air flowing into cylinders, and an intake-air-temperature sensor 14 that is one form of an intake-air-temperature sensing device and that measures an intake-air temperature.

In addition, the engine 100 includes, for each of cylinders (#1 to #4) communicating with one of the intake pipes 5, a fuel-injection device (also referred to as a cylinder direct injection injector or simply an injector) 3 that injects a fuel into a combustion chamber 11 of the corresponding cylinder, and an ignition system 4 that supplies ignition energy. In addition, the engine 100 includes, at an appropriate position of a cylinder head 6, a coolant-temperature sensor 13 that measures the temperature of a coolant of the engine 100.

In addition, a crank-angle sensor 12 that computes the rotation angle of a crankshaft (not illustrated) of the engine 100 is provided at the crankshaft, and a knock sensor 15 that senses vibrations (knocks) of the engine 100 is provided at a cylinder block (not illustrated) of the engine 100.

Furthermore, the engine 100 includes, at appropriate positions of exhaust pipes 7, a three-way catalyst 9 that purifies exhaust, an air-fuel-ratio sensor 8 that is one form of an air-fuel-ratio sensing device, and senses the air-fuel ratio of the exhaust on an upstream side of the three-way catalyst 9, and an exhaust-temperature sensor 10 that is one form of an exhaust-temperature sensing device and that measures the temperature of the exhaust on the upstream side of the three-way catalyst 9.

The engine 100 includes a control unit (engine control unit: ECU) 20 that controls the combustion state of the engine 100. Signals obtained from the air flow sensor 1, the air-fuel-ratio sensor 8, the coolant-temperature sensor 13, the intake-air-temperature sensor 14, the exhaust-temperature sensor 10, the crank-angle sensor 12, the ignition systems 4 and the knock sensor 15 that are described above are transmitted to the ECU 20. In addition, signals obtained from an accelerator-opening sensor 16 that senses the press-down amount of an accelerator pedal, that is, the accelerator opening, are also transmitted to the ECU 20.

On the basis of signals obtained from the accelerator-opening sensor 16, the ECU 20 calculates a required torque that the engine 100 is instructed to produce. In addition, the ECU 20 calculates the rotation speed of the engine 100 on the basis of signals obtained from the crank-angle sensor 12. In addition, on the basis of signals obtained from outputs of the various types of sensors described above, the ECU 20 calculates the running state of the engine 100, and also calculates major working amounts related to the engine 100 such as the ignition timing of the ignition systems 4 or the throttle opening of the electronic control throttle 2.

A fuel-injection amount calculated at the ECU 20 is converted into a valve-opening pulse signal, and transmitted to the fuel-injection devices 3. In addition, an ignition signal generated so as to start ignition at an ignition timing calculated at the ECU 20 is transmitted from the ECU 20 to the ignition systems 4. In addition, a throttle opening calculated at the ECU 20 is transmitted to the electronic control throttle 2 as a throttle drive signal.

On the basis of a valve-opening pulse signal transmitted from the ECU 20 to the fuel-injection device 3, a predetermined amount of fuel is injected from the fuel-injection devices 3 to air having flowed from the intake pipes 5 into the combustion chambers 11 via intake valves (not illustrated). Thereby, air-fuel mixtures are formed. The air-fuel mixtures formed in the combustion chambers 11 are caused to explode by sparks generated from ignition plugs (not illustrated) of the ignition systems 4 at predetermined ignition timings on the basis of an ignition signal. Due to the combustion pressures resulting therefrom, pistons (not illustrated) are pressed down to generate the driving force of the engine 100. The exhaust gas after the explosion is sent out to the three-way catalyst 9 via the exhaust pipes 7, and exhaust components in the exhaust gas are purified in the three-way catalyst 9, and discharged to the outside.

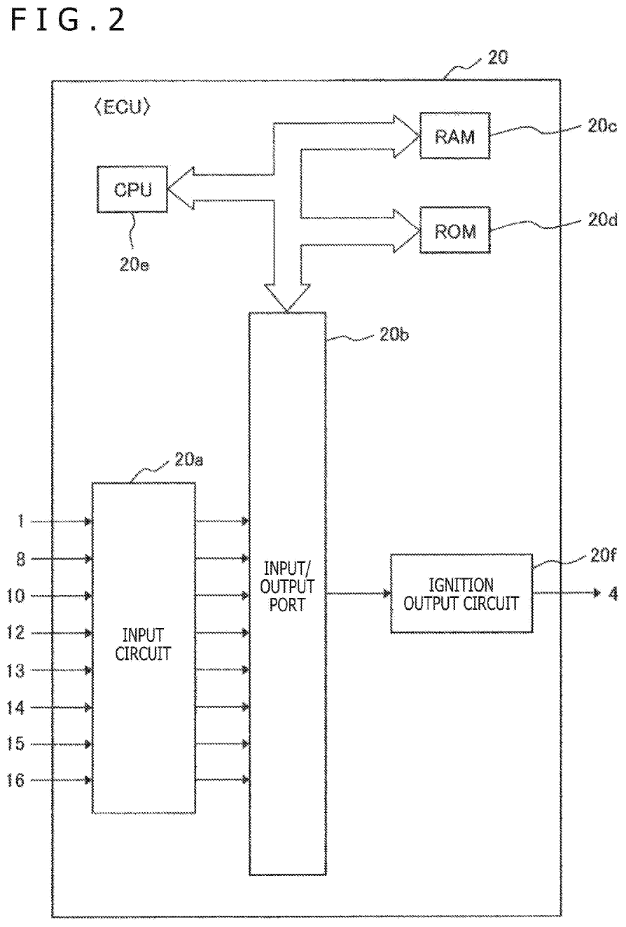

Next, the control unit (ECU) in the present embodiment is explained with reference to FIG. 2. FIG. 2 illustrates the internal configuration of the control unit (ECU) 20 illustrated in FIG. 1. The illustrated ECU 20 mainly includes: an input circuit 20a; an input/output port 20b including an input port and an output port; a ROM (Read Only Memory) 20d on which a control program describing calculation processing contents are stored; a CPU (Central Processing Unit) 20e for performing calculation processes in accordance with the control program; a RAM (Random Access Memory) 20c on which values calculated in accordance with the control program and indicating working amounts of actuators are stored; and an ignition output circuit 20f that controls sparks to be generated from the ignition plugs on the basis of the values indicating working amounts of the ignition plugs.

As illustrated in the drawing, the input circuit 20a of the ECU 20 receives inputs of output signals of the air flow sensor 1, the air-fuel-ratio sensor 8, the exhaust-temperature sensor 10, the crank-angle sensor 12, the coolant-temperature sensor 13, the intake-air-temperature sensor 14, the knock sensor 15, the accelerator-opening sensor 16 and the like. Note that input signals to be input to the input circuit 20a are not limited to these signals. The input signals of the sensors input to the input circuit 20a are transmitted to the input port in the input/output port 20b, and stored on the RAM 20c. Thereafter, the input signals are subjected to calculation processes at the CPU 20e in accordance with the control program stored on the ROM 20d in advance.

The values calculated at the CPU 20e in accordance with the control program and indicating the working amounts of the actuators are stored on the RAM 20c. Thereafter, the values are transmitted to the output port in the input/output port 20b, and transmitted to the ignition systems 4 via the ignition output circuit 20f. Note that drive circuits in the ECU 20 are not limited to these drive circuits. In addition, these drive circuits can also be provided outside the ECU 20.

Here, the input circuit 20a of the ECU 20 receives an input of the output signal of the knock sensor 15, and on the basis of the input signal (knock-sensor signal), at the CPU 20e, the ECU 20 senses an occurrence of knocking of the engine 100 in accordance with the control program stored on the ROM 20d in advance. In a case where the ECU 20 senses an occurrence of knocking of the engine 100, the ECU 20 transmits a control signal to the ignition systems 4 via the ignition output circuit 20f, and controls their ignition timings.

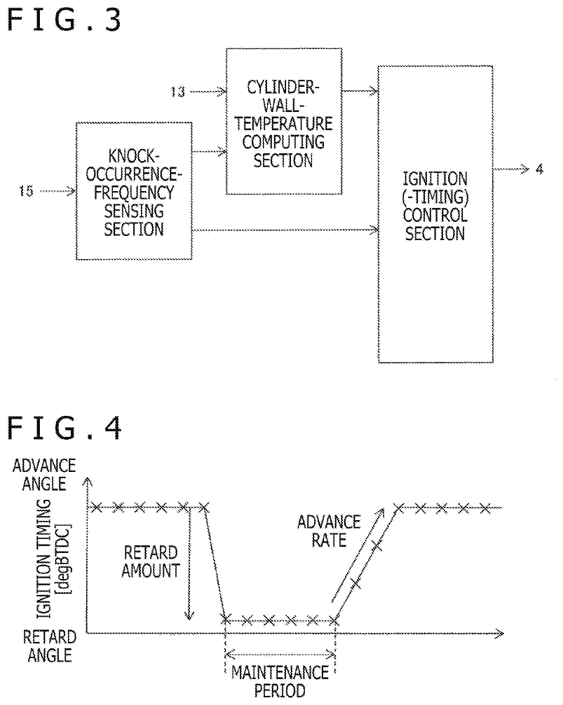

Next, methods for wall-temperature computation (estimation) and ignition-timing control of the engine 100 by the ECU 20 are explained with reference to FIG. 3 to FIG. 18.

FIG. 3 is a figure illustrating the overview of control logic for performing knock-occurrence-frequency sensing, cylinder-wall-temperature estimation and ignition-timing control that are performed in the control unit (ECU) 20 of the engine according to the present embodiment. The control unit (ECU) 20 is configured to include: a knock-occurrence-frequency sensing section that computes the occurrence-frequency of knocking (knocks) on the basis of an output of the knock sensor 15; a cylinder-wall-temperature computing section that computes the temperatures of the walls of cylinders on the basis of the computed knock occurrence-frequency, and an output of the coolant-temperature sensor 13; and an ignition(-timing) control section that sets a control method of ignition-timing control on the ignition systems 4 on the basis of the computed cylinder-wall temperature, and the computed knock occurrence-frequency.

FIG. 4 illustrates an example of control values related to ignition-timing control set at the ignition(-timing) control section. × (cross) in FIG. 4 indicates cycles. The difference between the ignition timing set for a cycle after a knock occurrence and the ignition timing at the time of the knock occurrence is a retard amount. The period during which the ignition timing is maintained in an ignition-retarded state is an ignition-maintenance period. In addition, the amount by which the ignition timing is advanced per unit time when ignition advancing is performed starting at the ignition-retarded state is the advance rate. As illustrated in FIG. 4, an ignition retard after the knock occurrence is performed in one cycle, and in a case where the advance control is performed, in many cases, the ignition timing is restored over multiple cycles to the ignition timing that has been adopted at the time of the knock occurrence.

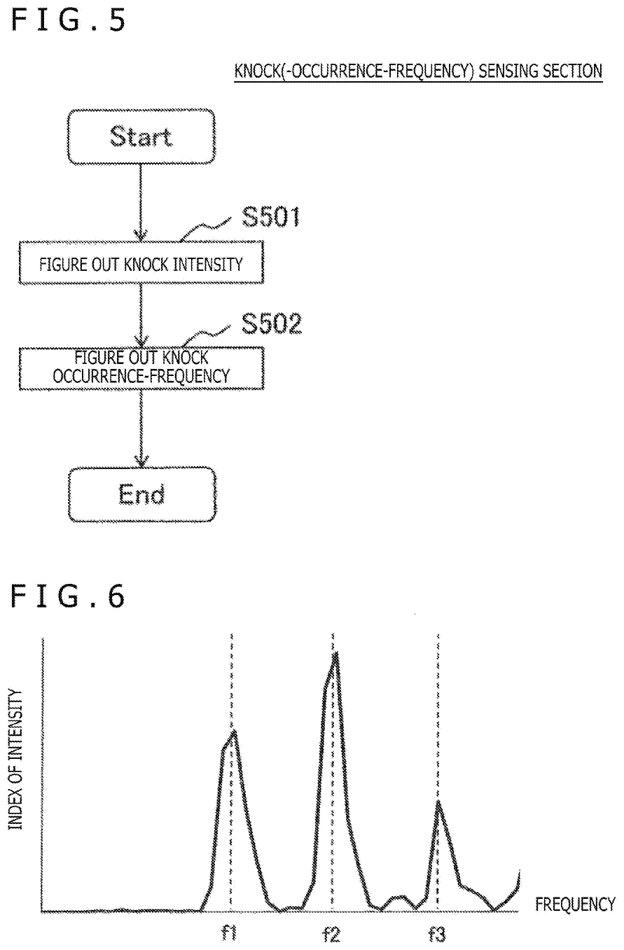

FIG. 5 is a flowchart illustrating a process performed at the knock-occurrence-frequency sensing section. First, at Step S501, the knock intensity is figured out. The knock intensity is sensed by performing a signal process on the vibration intensity of the engine block sensed at the knock sensor 15.

FIG. 6 illustrates the relationship between the vibration intensity and the frequency of the engine block at the time of a knock occurrence. It is known that, at the time of an occurrence of a knock, the knock exhibits frequency characteristics having peaks at particular frequencies (e.g. f1, f2 and f3 in FIG. 6) in accordance with the characteristics of pressure waves generated in cylinders and of the engine block. By making use of the fact that peaks appear at such particular frequencies, the vibration intensity (knock intensity) can be defined by the power spectra of the particular frequencies (f1, f2 and f3) or signals of the particular frequencies (f1, f2 and f3) extracted by using a bandpass filter.

For example, the vibration intensity can be defined by the weighted sum of the power spectrum of the frequency f1, the power spectrum of the frequency f2 and the power spectrum of the frequency f3.

Subsequently, at Step S502, the knock occurrence-frequency is figured out. For example, the occurrence-frequency Fk(K) of knocks in a K-th cycle can be defined by the ratio of the number (Nknock) of cycles in which knocks occurred to the number (Ntotal) of a plurality of past cycles, and can be represented by the following Formula 1.

[Equation 1]

Fk(K)=Nknock/Ntotal (Formula 1)

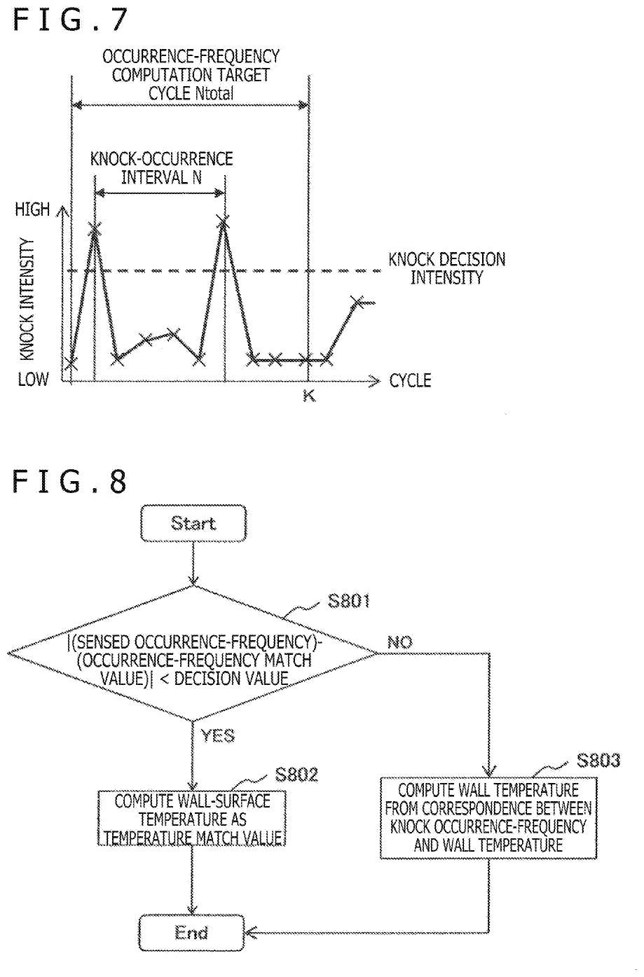

For example, in the case of the example of the knock occurrence-frequency (knock-occurrence interval) illustrated in FIG. 7, Ntotal is 10, Nknock is 2, and Fk(K) is 0.2.

In the case of Formula 1, information on cycles in which knocks have occurred in target cycles are stored, and information on the cycles in which knocks have occurred, the information being stored in a memory, is required to be updated as more cycles are gone through. Accordingly, a large storage capacity is necessary. In view of this, in another possible method, a knock-occurrence interval N like the one illustrated in FIG. 7 is used, it is hypothesized that one knock occurs in N cycles, and the occurrence-frequency Fk(K) is figured out according to the following Formula 2.

[Equation 2]

Fk(K)=a×Fk(K−1)+(1−a)×(1/N) (Formula 2)

Here, a is a weighting coefficient set to a positive real number equal to or smaller than 1. In a case where a greater weight is placed on newer information, a may be made larger. In Formula 2 also, an interval after an occurrence of the previous knock is required to be held in the memory. In view of this, the occurrence-frequency Fk(K) can be figured out according to the following Formula 3 by further simplification.

[Equation 3]

Fk(K)=((1−b(K))×(Ntotal×Fk(K−1)−1/Ntotal)+b(K))/Ntotal (Formula 3)

Here, b(K) is a numerical value that is set to 0 in a case where a knock does not occur in a K-th cycle, and is set to a positive value in a case where a knock occurred in the K-th cycle, and is appropriately set to a positive real number equal to or smaller than 1. The knock occurrence-frequency can be figured out by formulae like those mentioned above.

FIG. 8 is a flowchart of a process performed at the cylinder-wall-temperature computing section. First, the flow proceeds to Step S801, and it is decided whether or not the difference between a sensed knock occurrence-frequency (sensed occurrence-frequency) and an occurrence-frequency in a compliance-value condition (occurrence-frequency compliance value) is smaller than a predetermined value (decision value). The occurrence-frequency reference value (decision value) is determined in advance, and held in the ECU 20. In a case where errors in sensing of knocks are small, the occurrence-frequency reference value (decision value) can be made small.

In a case where it is decided at Step S801 that the difference is smaller than the occurrence-frequency reference value (decision value), the flow proceeds to Step S802, and the cylinder-wall temperature (wall-surface temperature) is computed as being the same as a temperature compliance value. On the other hand, in a case where it is decided at Step S801 that the difference is equal to or greater than the occurrence-frequency reference value (decision value), the flow proceeds to Step S803, and the cylinder-wall temperature (wall-surface temperature) is computed on the basis of the knock (occurrence-)frequency sensed at the knock-occurrence-frequency sensing section, according to a correspondence between the knock (occurrence-)frequency and the wall temperature.

FIG. 9 illustrates a correspondence between the knock occurrence-frequency and the wall temperature. The knock occurrence-frequency and the wall temperature have a positive correlation, and as the knock occurrence-frequency increases, the wall temperature increases. From this relationship, in a case where Fk(K) is higher than a reference value (occurrence-frequency compliance value) decided in engine control compliance tests, the wall temperature is relatively high as compared to a temperature compliance value (Tw, c); on the contrary, in a case where the knock occurrence-frequency Fk(K) is lower than the reference value (occurrence-frequency compliance value), the wall temperature is relatively low as compared to the temperature compliance value (Tw, c).

The relationship can also be represented by the knock occurrence-frequency and a relative temperature difference (ΔTw in the drawing) relative to the state corresponding to a compliance condition (occurrence-frequency compliance value) as illustrated in FIG. 10. By holding a correspondence like the ones illustrated in FIG. 9 and FIG. 10 in the ECU 20, the absolute value of the wall temperature and the temperature difference from the temperature compliance value can be computed from the relationship being held and the computed knock occurrence-frequency Fk(K).

Note that this correspondence is made clear (preset) in advance on the basis of experiments and/or simulations. With the process illustrated hereinbefore, the cylinder-wall temperature can be computed from knocking (knock) information based on outputs of generally-used sensors provided to an engine, and it becomes possible to apply the wall temperature to control of the ignition timing of the engine.

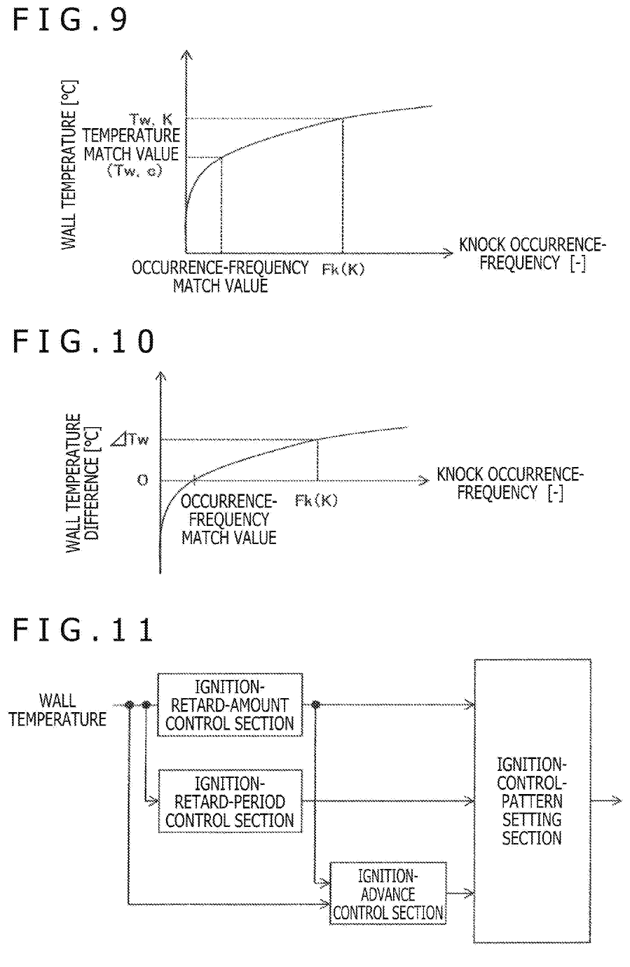

With reference to FIG. 11, the configuration of the ignition-timing control section of the control unit (ECU) in the present embodiment is explained. The ignition-timing control section includes: an ignition-retard-amount control section that sets a retard amount to be applied after a knock occurrence; an ignition-retard-period control section that sets a retard period; an ignition-advance control section that sets an advance rate and an advance amount; and furthermore an ignition-control-pattern setting section that set an ignition-control pattern on the basis of the set retard amount, retard period, advance rate and advance amount.

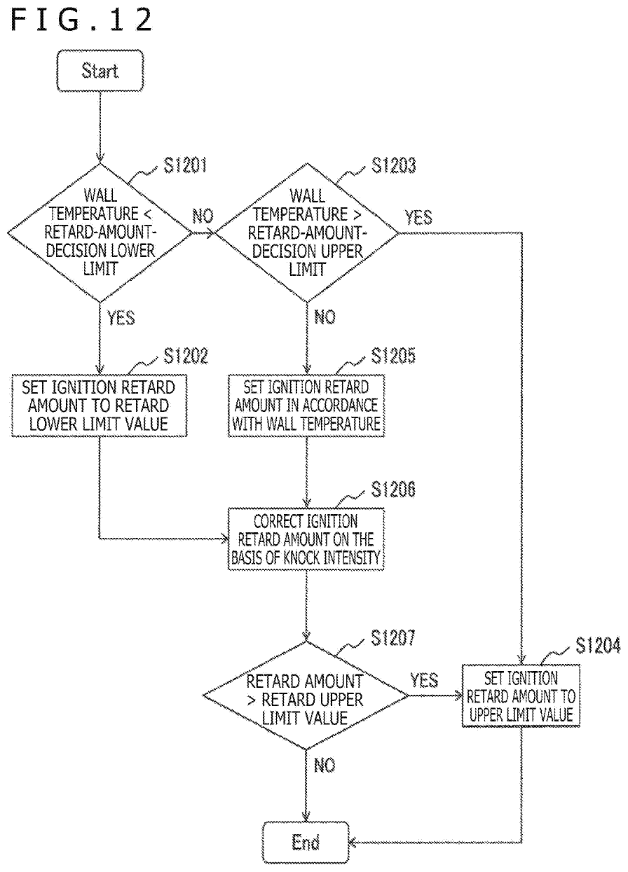

With reference to FIG. 12, a process performed at the ignition-retard-amount control section (retard-amount setting section) is explained.

First, at Step S1201, it is decided whether or not the wall temperature is smaller (lower) than a retard-amount-decision lower limit. In a case where the wall temperature is smaller (lower) than the retard-amount-decision lower limit, the flow proceeds to Step S1202, and the ignition retard amount is set to a retard lower limit value. Subsequently, the flow proceeds to Step S1206.

In a case where it is decided at the decision at Step S1201 that the wall temperature is equal to or higher than the retard-amount-decision lower limit, the flow proceeds to Step S1203. At Step S1203, it is decided whether or not the wall temperature is greater (higher) than a retard-amount-decision upper limit. In a case where it is decided that the wall temperature is greater (higher) than the retard-amount-decision upper limit, the flow proceeds to Step S1204, and the ignition retard amount is set to a retard upper limit value. In this manner, an excessive ignition retard amount is prevented by setting the predetermined retard upper limit value in advance.

Note that in a case where it is decided at Step S1203 that the wall temperature is equal to or lower than the retard-amount-decision upper limit, the flow proceeds to Step S1205, and the ignition retard amount is set in accordance with the wall temperature. Here, a correspondence having a positive correlation between the wall temperature and the ignition retard amount is held in the ECU 20 in advance, and the ignition retard amount is set on the basis of the correspondence. In this case, as the wall temperature rises, the ignition retard amount increases. In order to make the wall temperature close to that in a normal compliant state promptly, the amount of heat transfer to the wall surface is required to be reduced more, as the wall temperature rises. As illustrated by the explanation of Step S1205, as the wall temperature rises, the ignition retard amount is increased. Thereby, the amount of heat transfer to the wall surface can be set small, and lowering of the wall-surface temperature can be facilitated. As a result, it becomes possible to make the wall temperature close to that in the compliance state more promptly. Subsequently, the flow proceeds to Step S1206, and the ignition retard amount is corrected on the basis of the knock intensity.

Here, a correspondence having a positive correlation between the knock intensity and the ignition-retard correction amount is held in the ECU 20 in advance, and the ignition-retard correction amount is determined from the relationship. In the case of the correspondence described above, as the knock intensity increases, the correction amount of the ignition retard amount increases. As a result, the ignition retard amount can be set appropriately in accordance with the magnitude of the knock intensity, and an excessively small ignition retard and a recurrence of a highly intense knock resulting from the excessively small ignition retard can be suppressed.

Subsequently, the flow proceeds to Step S1207, and it is decided whether or not the determined ignition retard amount is larger than the ignition-retard-amount upper limit value per cycle (the retard upper limit value in FIG. 12). In a case where the retard amount is greater than the retard upper limit value, the flow proceeds to Step S1204, and the ignition retard amount is set to a retard upper limit value. On the other hand, in a case where the retard amount is smaller than the retard upper limit value, the flow ends and is exited.

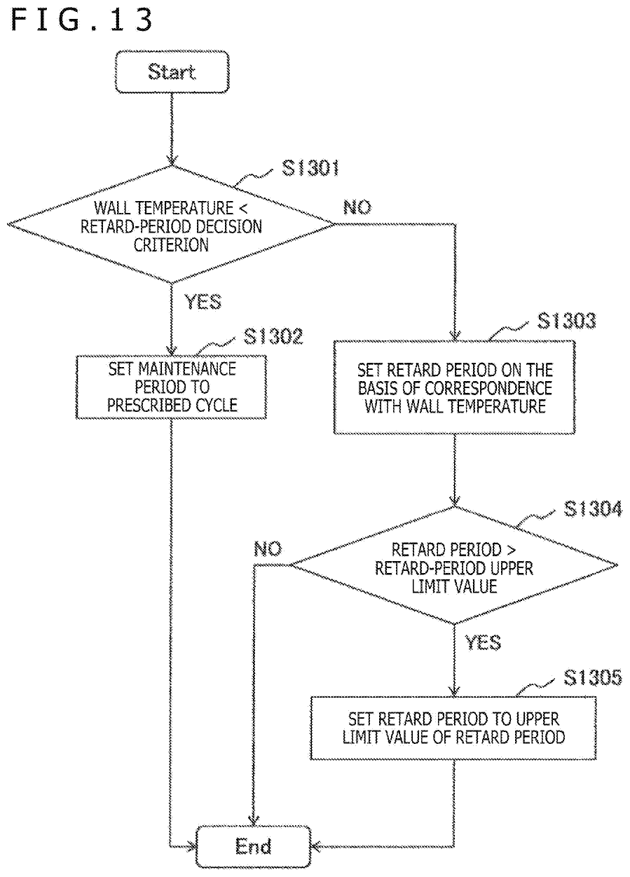

With reference to FIG. 13, a process performed at the ignition-retard-period control section is explained.

First, at Step S1301, it is decided whether or not the wall temperature is smaller (lower) than a retard-period decision criterion. In a case where the wall temperature is smaller (lower) than the retard-period-decision reference value, the flow proceeds to Step S1302, and the maintenance period of retard control is set to a predetermined prescribed cycle that is prescribed in advance. In a condition where the wall temperature is smaller (lower) than the retard-period decision criterion, it is not necessary to lower the wall temperature. Accordingly, for example, it is set such that the maintenance period is only one cycle and that an ignition retard is performed only for a cycle after a knock occurrence. With the thus-set process, it is possible to avoid excessively setting a period in which an ignition retard is performed, and it is possible to prevent efficiency deterioration due to an excessive ignition retard.

On the other hand, in a case where it is decided at Step S1301 that the wall temperature is equal to or higher than the retard-period decision criterion, the flow proceeds to Step S1303, and the ignition retard period is set in accordance with the wall temperature. Here, a correspondence having a positive correlation between the wall temperature and the ignition retard period is held in the ECU 20 in advance, and the maintenance period of retard control is set on the basis of the correspondence. In a case where the process is performed based on the correspondence, as the wall temperature rises, the ignition-retard maintenance period increases. With the thus-set process, it is possible to further reduce the amount of heat transfer to the wall surface in a condition where the wall temperature is high; as a result, it is possible to make the wall temperature close to the temperature compliance value more promptly.

Next, the flow proceeds to Step S1304, and it is concluded whether or not the set retard (maintenance) period is not longer than an upper limit value that can be set. In a case where it is decided that the set retard (maintenance) period is greater (longer) than the upper limit value that can be set, the flow proceeds to Step S1305, and the retard (maintenance) period is set to the upper limit value of the retard period. By doing so, it is possible to place a limitation on the retard period on the basis of the wall temperature, and it is possible to prevent a prolongation of a situation where an excessive retard (maintenance) period is set, and the efficiency deteriorates. On the other hand, in a case where the retard (maintenance) period is smaller (shorter) than the upper limit value, the flow ends and is exited.

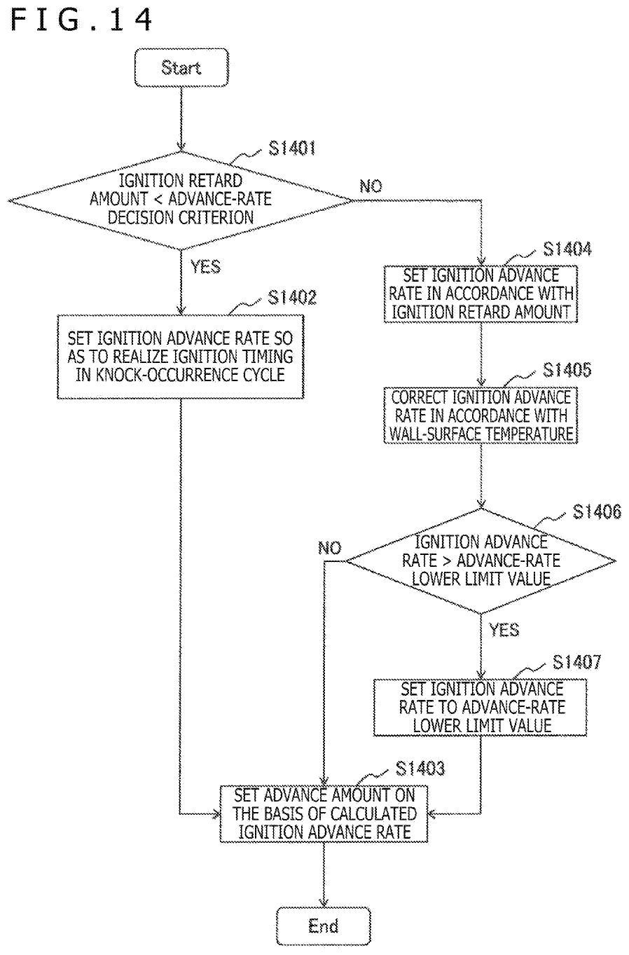

With reference to FIG. 14, a process performed at the ignition-advance control section (an advance-rate setting section) is explained.

First, at Step S1401, it is decided whether or not the ignition retard amount set at the ignition-retard-amount control section (retard-amount setting section) is smaller than an advance-rate decision criterion. In a case where it is decided at Step S1401 that the ignition retard amount is smaller than the advance-rate decision criterion, the flow proceeds to Step S1402, and the ignition advance rate is set such that the ignition timing to be restored after an ignition retard and a retard-maintenance period coincides with the ignition timing in a knock-occurrence cycle. For example, in a case where the ignition advance rate can be set as an ignition-timing advance amount for each combustion cycle, the advance rate is determined in accordance with the following Formula 4.

[Equation 4]

Advance rate (deg./cycle)=(Retard-cycle ignition timing (BTDC)−Knock-cycle ignition timing (BTDC)) (Formula 4)

The engine rotation speed can be calculated from the angle of the crank sensed at the crank-angle sensor 12. In addition, in a case where the target value is updated every time a certain length of time passes, the advance rate per unit time is calculated. In a case where the advance rate can be set as the advance amount of per unit time, the advance rate is determined in accordance with the following Formula 5.

[Equation 5]

Advance rate (deg./sec)=Engine rotation speed (rpm)/120(Retard-cycle ignition timing (BTDC)−Knock-cycle ignition timing (BTDC)) (Formula 5)

By determining the advance rate as mentioned above, it is possible to set the ignition timing to an ignition timing equivalent to the ignition timing in the knock-occurrence cycle when the ignition timing is restored after the ignition retard. With the thus-set process, it is possible to make shorter a period during which an ignition retard is performed and to make shorter a period during which an exhaust loss increases in a condition where the ignition retard amount is small. Accordingly, efficiency deterioration of an internal-combustion engine can be prevented. Subsequently, the flow proceeds to Step S1403.

On the other hand, in a case where it is decided at Step S1401 that the ignition retard amount is equal to or larger than the advance-rate decision criterion, the flow proceeds to Step S1404, and an ignition advance rate according to the ignition retard amount is set. Here, a correspondence having a negative correlation between the ignition retard amount and the ignition advance rate is held in the ECU 20 in advance, and the ignition advance rate is set by using the relationship. The ignition advance rate that is set at this time can be an advance amount for each combustion cycle or can be an advance amount per unit time, depending on the control specifications. By setting the ignition advance rate by using the correspondence having the negative correlation between the ignition retard amount and the ignition advance rate, a lower advance rate can be set as the ignition retard amount increases.

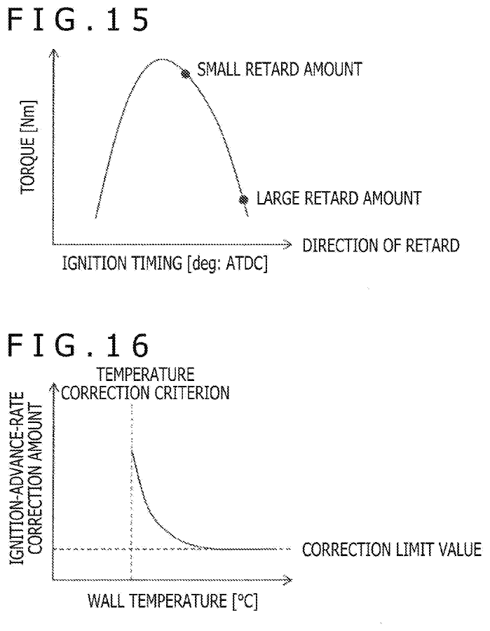

Here, as illustrated in FIG. 15, the torque variation amount in relation to the ignition retard amount show s non-linearity, and the torque is represented by a function which shows a curve projected upwardly in relation to the ignition timing. In addition, as compared to a condition where the retard amount is small, in a condition where the retard amount is large, the rate of change of the torque in relation to the ignition timing is large. That is, if ignition advances are performed with the same amount in a condition where the retard amount is small, and in a condition where the retard amount is large, the variation of the torque is large in the condition where the retard amount is large.

Because of this, the extent (degree) of the torque variation due to an ignition advance can be effectively adjusted by changing the advance rate in accordance with an ignition retard amount. In this manner, by setting the ignition advance rate taking into consideration the ignition retard amount, it is possible to perform an ignition advance taking into consideration the torque variation in relation to the ignition-timing change that changes in accordance with the retard amount. Accordingly, it is possible to suppress the extent (degree) of the torque variation to an appropriate level.

Subsequently, the flow proceeds to Step S1405, and the ignition advance rate is corrected in accordance with the wall-surface temperature. Here, a correspondence having a negative correlation between the wall-surface temperature and the ignition-advance-rate correction amount, and/or a correspondence between the wall-surface temperature and the ignition-advance-rate correction amount like the one illustrated in FIG. 16 are held in the ECU 20 in advance, and the relationship(s) is/are used for correction. By correcting the ignition advance rate by using the correspondence having the negative correlation between the wall temperature and the ignition-advance-rate correction amount, the ignition advance rate can be set lower as the wall temperature rises. Thereby, it is possible to prolong a period during which an ignition is retarded (retarded) in a condition where the wall temperature is high. Accordingly, it is possible to make the wall temperature close to the temperature compliance value more promptly.

In addition, the probability of a knock occurrence accompanying a knock advance is high in a condition where the wall temperature is high. If a knock occurs during an advance, a large ignition retard is generated, and this leads to fuel-efficiency deterioration. By reducing the ignition advance rate in a condition where the wall temperature is high, occurrences of knocks during an advance and the number of times of performing ignition retards following the occurrences of knocks are reduced; as a result, it is possible to prevent efficiency deterioration.

In addition, as illustrated in FIG. 16, by providing a reference value (temperature correction criterion) in a temperature condition under which correction is performed, it is possible to suppress lowering of an ignition advance rate in a condition where the wall temperature is low. In addition, by providing a correction limit value for the correction amount, it is possible to avoid excessive lowering of the ignition advance rate. With the thus-set process, it is possible to prevent unnecessary lowering of the ignition advance rate, and it is possible to prevent efficiency deterioration that may otherwise be caused by excessive prolongation of an ignition retard period.

Next, the flow proceeds to Step S1406, and it is decided whether or not the ignition advance rate that is determined as a result of the process thus far is smaller than an advance-rate lower limit value. In a case where the ignition advance rate is smaller than the advance-rate lower limit value, the flow proceeds to Step S1407, and the ignition advance rate is set to the advance-rate lower limit value. In a case where it is concluded at Step S1406 that the ignition advance rate is larger than the advance-rate lower limit value, the flow proceeds to Step S1403.

At Step S1403, the ignition advance amount is set in accordance with an adopted control cycle and technique. For example, if the ignition advance amount is set for the control cycle, the advance amount is given as the product of the ignition advance rate defined by the advance amount per unit time and the control cycle (time). On the other hand, if the ignition advance amount for each combustion cycle is given, the advance amount is given on the basis of the advance rate defined by the advance amount for each combustion cycle. For example, in a case where the ignition retard amount in the preceding combustion cycle (first combustion cycle) is smaller than a predetermined reference value, the ignition advance amount is controlled such that the ignition advance amount from the preceding combustion cycle (first combustion cycle) until the following combustion cycle (second combustion cycle) increases.

With the process mentioned above, the ignition advance rate and the ignition advance amount can be set, appropriate advance control can be performed in accordance with the ignition retard amount and/or the wall temperature, and it is possible to attempt to suppress the torque variation, promptly lower the wall temperature and suppress occurrences of knocks during an ignition advance.

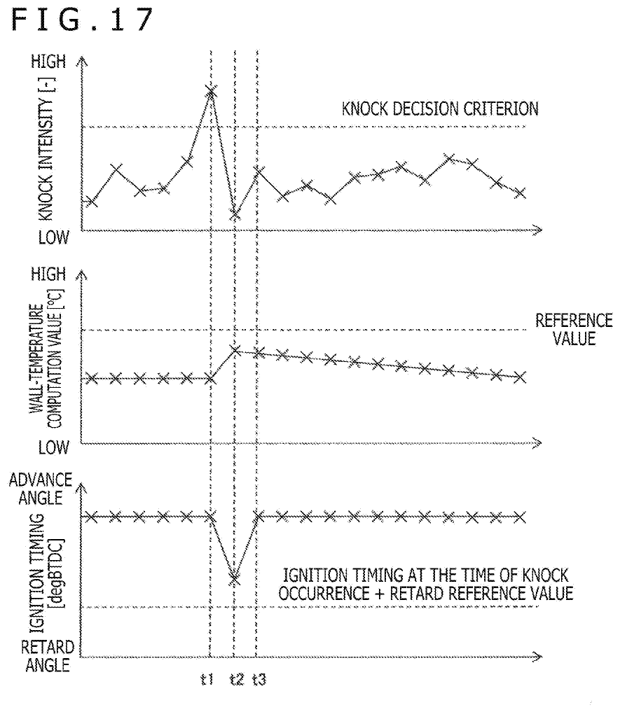

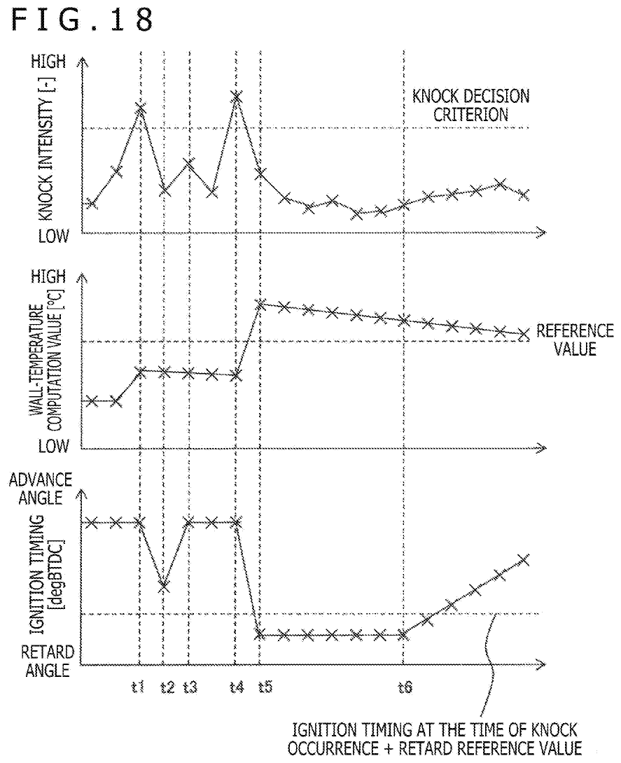

With reference to FIG. 17 and FIG. 18, operation results of the present embodiment are explained. × (cross) in FIG. 17 and FIG. 18 indicates cycles. FIG. 17 illustrates an operation result in a condition where the wall temperature is low, and FIG. 18 illustrates an operation result in a condition where the wall temperature is high.

In FIG. 17 (a condition where the wall temperature is low), the knock intensity is greater than the knock decision criterion at time t1, and it is decided that a knock is occurring. Following the occurrence of the knock, at time t2, the estimated temperature (wall-temperature computation value) increases. In addition, since time t2 corresponds to a combustion cycle following (immediately after) the occurrence of the knock, the ignition timing is retarded (retard control). Since, in this condition, the ignition retard amount is smaller than the reference value, at t3, the ignition timing is restored to a timing equivalent to the ignition timing in the knock-occurrence cycle on the basis of the setting performed at step S1402 of FIG. 14. At and after t3, the estimated temperature (wall-temperature computation value) decreases along with the passage of cycles.

In a condition where the ignition retard amount at the time of a retard is small, it is possible to perform retard control and advance control for ignition timings in this manner. As a result of the thus-set process, it is possible to suppress generation of an excessive ignition retard amount and/or retard (maintenance) period in a condition where the wall temperature is low, and it is possible to suppress deterioration of the system efficiency.

On the other hand, in FIG. 18 (a condition where the wall temperature is high), the knock intensity is greater than the knock decision reference value at time t1 and time t4. As a result, the computed wall temperature is greater than the reference value, and at and after time t5, the ignition retard period is set based on the wall temperature in the process of Step S1303 in FIG. 13. The retard amount and/or the retard (maintenance) period are/is set on the basis of the estimated wall temperature in this manner, and furthermore in a case where the retard amount is large, an excessive advance rate is not set. Accordingly, it is possible to perform efficient ignition-timing control in which excessive lowering of the wall temperature and torque variation are suppressed.

As explained above, according to the present invention, it is possible to prevent an excessive ignition-timing retard while occurrences of knocking are suppressed, and it is possible to attempt to enhance fuel efficiency.

Note that it is possible to check whether or not the present invention is implemented not only by checking the hardware configuration of an engine control unit (ECU), but also by checking ignition-retard control signals (patterns) and the like from the ECU, for example.

In addition, the present invention is not limited to the embodiments described above, but includes various variants. For example, the embodiments described above are explained in detail in order to explain the present invention in an easy-to-understand manner, and embodiments are not necessarily limited to the ones including all the configurations that are explained. In addition, some of the configurations of an embodiment can be replaced with configurations of another embodiment, and configurations of an embodiment can be added to the configurations of another embodiment. In addition, some of the configurations of each embodiment can be subjected to addition, deletion or replacement of other configurations.

### DESCRIPTION OF REFERENCE CHARACTERS

1: Air flow sensor
2: Electronic control throttle
3: Fuel-injection device (injector)
4: Ignition system
5: Intake pipe
6: Cylinder head
7: Exhaust pipe
8: Air-fuel-ratio sensor
9: Three-way catalyst
10: Exhaust-temperature sensor
11: Combustion chamber
12: Crank-angle sensor
13: Coolant-temperature sensor
14: Intake-air-temperature sensor
15: Knock sensor
16: Accelerator-opening sensor
20: Control unit (engine control unit: ECU)
20a: Input circuit
20b: Input/output port
20c: RAM (Random Access Memory)
20d: ROM (Read Only Memory)
20e: CPU (Central Processing Unit)
20f: Ignition output circuit
100: Engine (internal-combustion engine)

1. An internal-combustion-engine control unit that controls an internal-combustion engine, the internal-combustion-engine control unit comprising:
a knock-occurrence-frequency sensing section that senses a knock occurrence-frequency of a cylinder; and
a cylinder-wall-temperature computing section that computes a wall temperature of the cylinder on a basis of the knock occurrence-frequency sensed at the knock-occurrence-frequency sensing section.

2. The internal-combustion-engine control unit according to claim 1, comprising:
an ignition-timing control section that controls an ignition timing of the internal-combustion engine on a basis of the wall temperature of the cylinder, the wall temperature being computed at the cylinder-wall-temperature computing section.

3. The internal-combustion-engine control unit according to claim 2, wherein
the ignition-timing control section comprises:
an ignition-retard-amount control section that sets a retard amount after a knock occurrence;
an ignition-retard-period control section that sets a retard period;
an ignition-advance control section that sets an advance rate and an advance amount; and
an ignition-control-pattern setting section that sets an ignition-control pattern of the internal-combustion engine on a basis of the retard amount set by the ignition-retard-amount control section, the retard period set by the ignition-retard-period control section and the advance rate and the advance amount set by the ignition-advance control section.

4. The internal-combustion-engine control unit according to claim 3, comprising:
a knock sensing section that senses a knock occurrence of the internal-combustion engine, wherein
the ignition-timing control section performs ignition retard control of the internal-combustion engine immediately after a knock is sensed at the knock sensing section, and determines the ignition retard period on a basis of the wall temperature of the cylinder, the wall temperature being computed at the cylinder-wall-temperature computing section.

5. The internal-combustion-engine control unit according to claim 4, wherein,
in a case where the wall temperature of the cylinder, the wall temperature being computed at the cylinder-wall-temperature computing section, is higher than a predetermined reference value, the ignition-timing control section performs control such that the ignition retard period or the ignition retard amount is increased.

6. The internal-combustion-engine control unit according to claim 4, wherein,
in a case where an intensity of the knock sensed at the knock sensing section is higher than a predetermined reference value, the ignition-timing control section performs control such that the ignition retard amount is increased.

7. The internal-combustion-engine control unit according to claim 4, wherein
in a case where an occurrence of a knock is sensed at the knock sensing section, an ignition timing is retarded in a first combustion cycle by the ignition-retard-amount control section and the ignition-retard-period control section, and
in a case where an ignition timing is advanced at a second combustion cycle subsequent to the first combustion cycle, and where the ignition retard amount in the first combustion cycle is smaller than a predetermined reference value, the ignition-advance control section controls an ignition advance amount such that the ignition timing in the second combustion cycle coincides with an ignition timing at which the occurrence of the knock is sensed.

8. The internal-combustion-engine control unit according to claim 4, wherein,
in a case where an occurrence of a knock is sensed at the knock sensing section, an ignition timing is retarded in a first combustion cycle by the ignition-retard-amount control section and the ignition-retard-period control section, and
in a case where an ignition timing is advanced at a second combustion cycle subsequent to the first combustion cycle, and where the ignition retard amount in the first combustion cycle is smaller than a predetermined reference value, the ignition-advance control section controls an ignition advance amount such that an ignition advance amount from the first combustion cycle until the second combustion cycle increases.

9. The internal-combustion-engine control unit according to claim 7, wherein,
in a case where the wall temperature of the cylinder, the wall temperature being computed at the cylinder-wall-temperature computing section is higher than a predetermined reference value, control is performed such that the ignition advance amount is reduced.

10. An internal-combustion-engine control method of controlling an internal-combustion engine, the method comprising:
a step (a) of sensing a knock occurrence-frequency of a cylinder; and
a step (b) of computing a wall temperature of the cylinder on a basis of the knock occurrence-frequency sensed at the step (a), wherein
an ignition timing of the internal-combustion engine is controlled on a basis of the wall temperature of the cylinder, the wall temperature being computed at the step (b).

11. The internal-combustion-engine control method according to claim 10, comprising:
a step (c) of deciding whether or not the wall temperature of the cylinder, the wall temperature being computed at the step (b), is within a predetermined range, wherein
in a case where it is decided that the wall temperature of the cylinder is within the predetermined range, an ignition retard amount of the internal-combustion engine is set in accordance with the wall temperature of the cylinder.

12. The internal-combustion-engine control method according to claim 10, comprising:
a step (c) of comparing the wall temperature of the cylinder, the wall temperature being computed at the step (b), with a predetermined reference value, wherein
in a case where it is decided that the wall temperature of the cylinder is equal to or higher than the predetermined reference value, an ignition retard period of the internal-combustion engine is set in accordance with the wall temperature of the cylinder.

13. The internal-combustion-engine control method according to claim 11, comprising:
a step (d) of comparing the set ignition retard amount with a predetermined reference value, wherein
in a case where it is decided that the set ignition retard amount is equal to or higher than the predetermined reference value, an ignition advance rate of the internal-combustion engine is set in accordance with the ignition retard amount, and the set ignition advance rate is corrected in accordance with the wall temperature of the cylinder.

14. The internal-combustion-engine control method according to claim 10, wherein
the knock occurrence-frequency is computed in accordance with a following Formula 1 at the step (a):
[Equation 1]
Fk(K)=a×Fk(K−1)+(1−a)×(1/N) (Formula 1)
where Fk(K) is the knock occurrence-frequency in a K-th cycle of the internal-combustion engine, N is a knock-occurrence interval, and a is a predetermined weighting coefficient.

15. The internal-combustion-engine control method according to claim 10, wherein
the knock occurrence-frequency is computed in accordance with a following Formula 2 at the step (a):
[Equation 2]
Fk(K)=((1−b(K))×(ntotal×Fk(K−1)−1/Ntotal)+b(K))/Ntotal (Formula 2)
where Fk(K) is the knock occurrence-frequency in a K-th cycle of the internal-combustion engine, Ntotal is the total number of cycles, and b is a predetermined coefficient.
